(19) United States
(12) Patent Application Publication
(10) Pub. No.: US 2013/0070830 A1
(43) Pub. Date: Mar. 21, 2013

(54) CHARACTERIZATION OF THE JITTER OF A CLOCK SIGNAL

(71) Applicant: Herve LE-GALL, Saint-Martin d'Uriage (FR)

(72) Inventor: Herve LE-GALL, Saint-Martin d'Uriage (FR)

(73) Assignee: STMicroelectronics (Grenoble2) SAS, Grenoble (FR)

(21) Appl. No.: 13/613,200

(22) Filed: Sep. 13, 2012

(30) Foreign Application Priority Data
Sep. 15, 2011 (FR) 1158219

(51) Int. Cl. H04B 17/00

(52) U.S. Cl. 375/226

(57) ABSTRACT

A method for characterizing jitter of an internal clock signal of a circuit may include generating a series of samples of the internal clock signal by a reference clock signal, comparing the word formed by the N most recent samples of the series to an N-bit pattern, where N is an integer greater than, or equal to 2, and incrementing a first counter if the word complies with the pattern. The method may also include incrementing a second counter when the count of the first counter reaches a first threshold X1, and incrementing a third counter when the count of the first counter reaches a second threshold different from the first. The method may include calculating an average p and a standard deviation σ of a Gaussian density curve as a function of the counts reached in the second and third counters.

### FIELD OF THE INVENTION

The invention relates to analysis of jitter in a clock signal of a circuit, and more particularly to a built-in self-test device cooperating with an external test apparatus to perform the analysis.

### BACKGROUND OF THE INVENTION

Jitter is the fact that the edges of a real periodic signal do not occur at expected times in practice, but with a certain margin of uncertainty around these times. FIG. 1 shows, for an alternation of a clock signal (first curve), two typical models allowing jitter to be characterized and an error probability to be determined. When the clock signal is used to sample data of a serial transmission, the error probability is the bit error rate BER.

For a long time, jitter has been modeled as a random phenomenon following the so-called Gaussian normal law. Thus, as shown on the second curve, jitter for each edge is characterized by a normal probability density or Gaussian curve, centered on the edge. Curve spreading, defined by the standard deviation, shows the margin of uncertainty. Error rate BER corresponds to the intersection surface of the density curves associated to two consecutive edges. Thus, the error rate increases with the standard deviation.

More recently, it has been sought to model jitter by a more realistic probability density, called “Dual Dirac,” according to the third curve of FIG. 1. It is defined that jitter is formed by a random component “RJ” and a deterministic component “DJ.” These components depend on the architecture of the circuit generating the clock signal. The “Dual Dirac” density function is a convolution of a Gaussian function, representing the random component RJ, and two Dirac functions, centered at +p and −μ with respect to the theoretical edge of the clock signal. Deterministic jitter is then expressed by DJ=2μ. Error rate BER also corresponds to the intersection surface of the density curves associated to two consecutive edges.

The document (“Jitter Analysis: The dual-Dirac Model, RJ/DJ, and Q-Scale,” White Paper, Agilent Technologies, Dec. 31, 2004) discloses a method for calculating the jitter parameters when it is characterized by a “Dual Dirac” function. This method assumes that the variations of the position of the edges of the observed signal can be measured accurately. The measures are classified in a histogram allowing the probability density to be reconstructed, over a large number of measurements. The tail of the density curve thus found is approximated to an off-centered Gaussian curve representing the random part RJ of the measured jitter. Using this approximation, the average value and standard deviation of the Gaussian curve are deduced, which tend to be near the parameters μ and σ of a dual-Dirac density curve. These parameters also allow the error rate BER to be calculated.

In production, during the test after manufacture of integrated circuits, a jitter indicator may be helpful, so as to discard the circuits which would have unacceptable error rates. Such a test should be performed in around one hundred milliseconds and use standard test equipment, unable to measure the positions of clock edges. It is then not conceivable to use the method described in the Agilent document.

FIG. 2 shows a method and approach described by U.S. Pat. No. 7,487,055 to identify circuits which would have excessive error rates. In a built-in self-test (GIST) device of the circuit, an internal clock signal CKint to be observed is sampled by a reference clock signal CKref having a frequency slightly offset from that of signal CKint.

Thus, the signal Sbt formed by the resulting samples theoretically evolves at the beat frequency of signals CKint and CKref, whose half-periods are indicated by vertical lines in FIG. 2. In reality, as shown, the edges of signal CKint are not regular due to jitter. The result is that, in particular, near the theoretical transitions of the beat signal Sbt, there are sampling errors.

Some patterns found in signal Sbt are considered to be representative of significant jitter and the self-test device counts the number of occurrences over a measurement interval representing a statistically sufficient number of clock cycles. The patterns 10X1/01X0 are suggested in particular (where “X” represents any number of bits of any state). If the number of occurrences exceeds a threshold at the end of the interval, the self-test device indicates that jitter is unacceptable. Although this approach may be usable in a test environment in production, it does not supply any jitter characterization parameter, which would be useful to find default causes, in particular, the deterministic jitter part.

### SUMMARY OF THE INVENTION

An approach may allow jitter characterization parameters to be supplied, which is usable in a test environment in production, without requiring any accurate measurement device.

An aspect is directed to a method for characterizing the jitter of an internal clock signal of a circuit. The method may include generating a series of samples by sampling the internal clock signal by a reference clock signal, comparing the word formed by the N most recent samples of the series to a N-bit pattern, where N is an integer greater than, or equal to 2, and incrementing a first counter if the word complies with the pattern. The method may comprise incrementing a second counter when the count of the first counter reaches a first threshold X-1, incrementing a third counter when the count of the first counter reaches a second threshold X2 different from the first, periodically resetting the first counter, and at the end of an observation interval, calculating an average p and a standard deviation σ of a Gaussian density curve as a function of the counts reached in the second and third counters, considering these counts as the accumulated totals for the classes X1 and X2 of a histogram of the complementary cumulative distribution function associated to the Gaussian density curve.

According to an embodiment, compliance with the pattern may be achieved when any two bits of the word are different. The two thresholds may be chosen high enough for the effects of possible other density functions involved in the jitter characterization or produced by the measurement conditions to be negligible. Additionally, the first counter may be reset at a frequency which is twice a beat frequency between the internal clock signal and the reference clock signal.

Another aspect is directed to a BIST circuit allowing collection of information usable for characterizing the jitter of an internal clock signal. The BIST circuit may comprise a shift register receiving the internal clock signal and clocked by a reference clock signal, a detector configured to evaluate the compliance of the shift register content with an N-bit pattern, where N is an integer greater than, or equal to 2, and a first counter configured to be incremented by the detector upon a compliance detection. The BIST circuit may also include a second counter connected to be incremented when the content of the first counter reaches a first threshold X1. The BIST circuit may comprise a third counter connected to be incremented when the content of the first counter reaches a second threshold X2 different from the first.

A management circuit may be configured to clock the second and third counters at a frequency which is twice the beat frequency between the internal clock signal and the reference clock signal, and to reset the first counter at the same rate. According to an embodiment, the detector may be configured to supply an active signal when any two bits of the shift register differ.

### BRIEF DESCRIPTION OF THE DRAWINGS

Embodiments of the invention will be described in the following description, in relation with, but not limited to the appended figures wherein:

FIG. 1 shows probability density curves used to characterize the jitter of a clock signal, according to the prior art.

FIG. 2 shows a digital timing diagram of a technique which is the basis of the development of a binary jitter criterion, according to the prior art.

FIG. 3 shows a digital timing diagram used as a starting point of a jitter characterization technique, according to the present invention.

FIG. 4 shows a probability density curve resulting from the transformation of a dual-Dirac function by the measurement conditions shown in FIG. 3, according to the present invention.

FIG. 5 shows a complementary cumulative distribution function curve associated to the density of FIG. 4, according to the present invention.

FIG. 6 is a schematic diagram of an embodiment of a BIST device allowing the collection of data used to characterize the jitter, according to the present invention.

FIG. 7 is a schematic diagram of a second embodiment of a BIST device, according to the present invention.

FIG. 8 shows a digital timing diagram similar to that of FIG. 3, illustrating the operation of the circuit of FIG. 7 in a particular case.

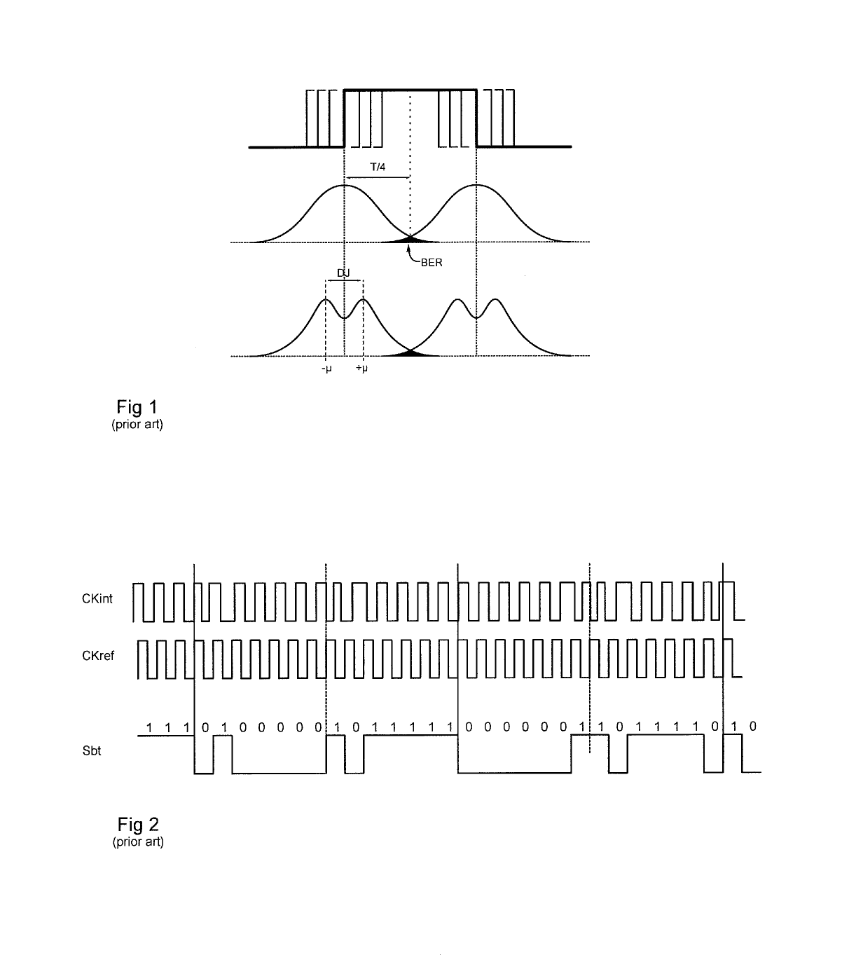

### DETAILED DESCRIPTION OF THE PREFERRED EMBODIMENTS

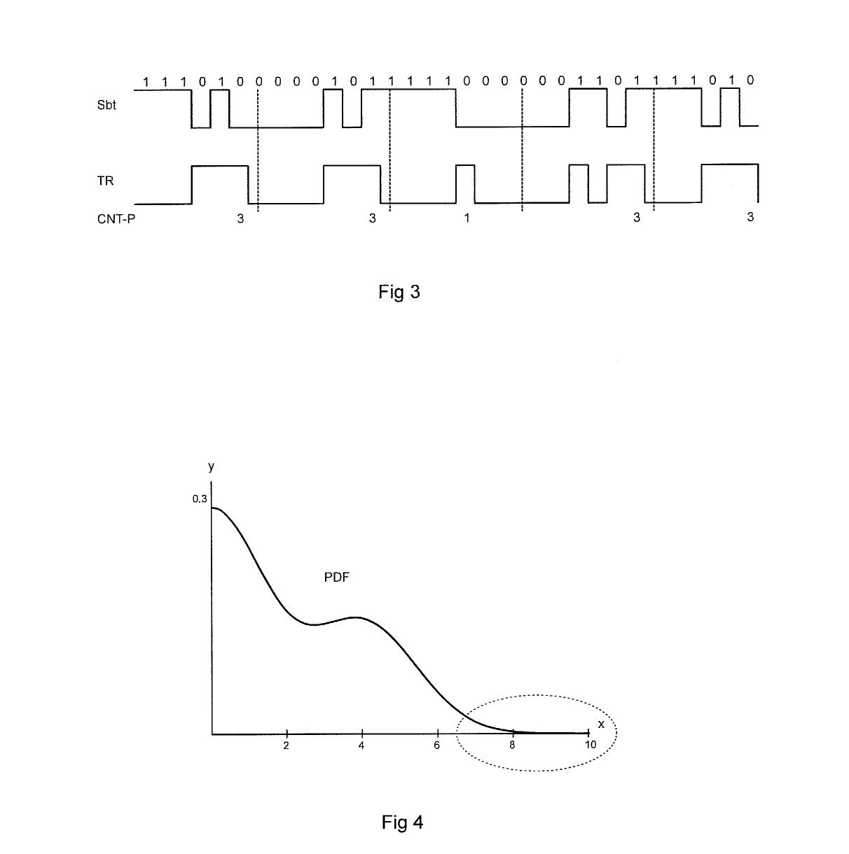

FIG. 3 shows a beat signal Sbt, complying with FIG. 2, obtained after sampling the observed clock signal CKint by the reference clock signal CKref. As in the above-mentioned '055 patent, the pattern occurrences in signal Sbt are counted. In FIG. 3, the occurrences of the patterns 01 and 10 are counted, which in fact show the transitions of signal Sbt. Each pattern occurrence is indicated by a state 1 of a signal TR. The number of cycles (of clock CKref) during which signal TR is at 1 is counted in a counter CNT-P.

Instead of indefinitely incrementing counter CNT-P over the test interval, as disclosed in the above-mentioned '055 patent, the counter is periodically reset, preferably between two theoretical edges of beat signal Sbt, at times indicated by vertical dotted lines. Thus, counter CNT-P indicates the number of pattern occurrences for each theoretical edge of signal Sbt. FIG. 3 indicates the counts corresponding to the example shown.

These counts happen to be correlated to the jitter. In fact, they are considered here as measures representing instantaneous jitter, which are used to build a probability density histogram, as if these counts were measures of the edge positions. From this histogram, jitter characteristics may be deduced according to typical methods.

Jitter is preferably modeled according to the dual-Dirac density function. However, as the used measurement technique does not distinguish positive deviations from negative deviations, the dual-Dirac density function is transformed by convolution of its left part on its right part.

If Gμ, σ is the Gaussian density function of average value μ and standard deviation σ, the dual-Dirac function is expressed as follows:

DDμ,σ=1/2G-μ,σ+1/2Gμ,σ.

The transformed dual-Dirac function, defined only for positive real numbers, is expressed as follows:

DD*μ,σ=1/2G-μ,σ+G0,σ+1/2Gμ,σ.

FIG. 4 shows an example of variation curve of the transformed density function DD* for μ=4 and σ=√2. The values on the Y axis are standardized by the number of values counted over the observation interval. As in a typical dual Dirac function, the tail, surrounded by a dotted line in FIG. 4, of transformed function DD* may also be approximated by a Gaussian curve, more specifically the function ½Gμ,σ, which becomes predominant in the expression of function DD* for higher values of X. Thus, by finding enough tail points, the parameters of the Gaussian curve Gμ,σ may be deduced.

In practice, the curve of FIG. 4 may be built in the form of a histogram, where each class X is a possible count of counter CNT-P, and contains the number of times this count has been reached during the observation interval. The tail corresponds to the lowest probabilities, therefore to the counts occurring the least often. The observation interval, i.e. the circuit test time, should be relatively large so that these numbers are significant enough.

Some embodiments will rather use the complementary cumulative distribution function associated to the probability density, in other words the integral from X to the infinite of the probability density, which represents, in terms of histograms, the accumulation of the counts greater than, or equal to X. Thus, when a value in a class X is considered, this value is the accumulated total of all the occurrences of classes X and above. This produces a more significant number of values than in the case of a probability density histogram, which helps improve accuracy while using a shorter observation interval.

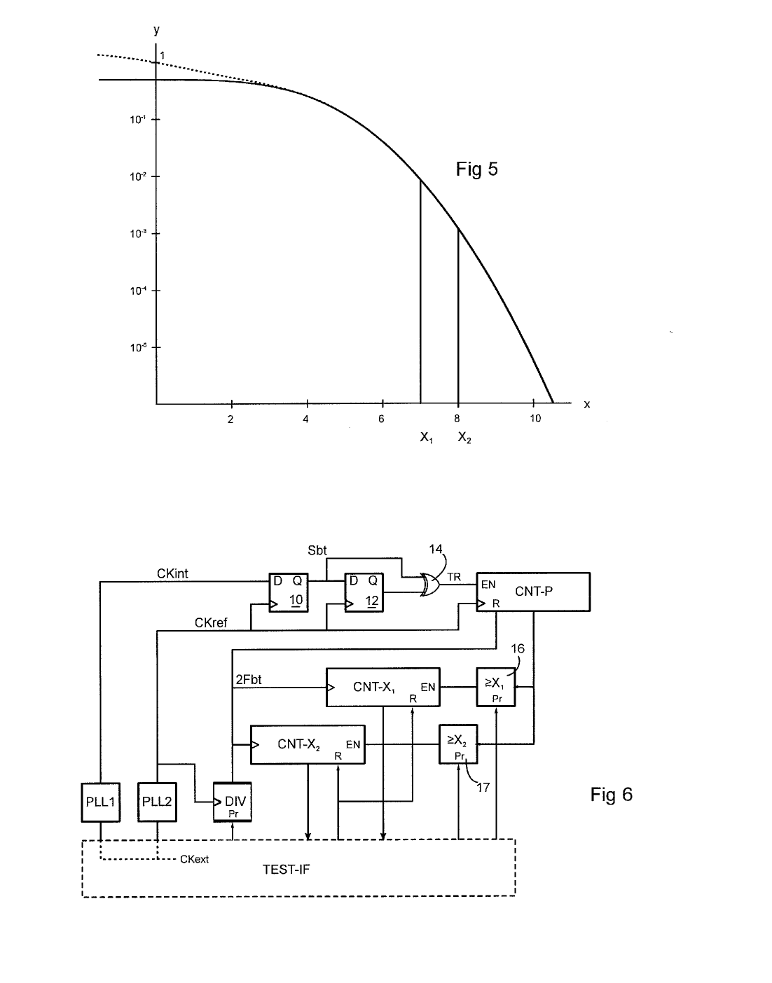

FIG. 5 shows in a dotted line the variation of the complementary cumulative distribution function associated to the probability density of FIG. 4, with the Y axis in logarithmic scale. The complementary cumulative distribution function associated to the curve ½Gμ,σ is shown in solid line. As shown, both curves are the same from X=μ=4, in this example. It will suffice to use values of X higher than 4 to deduce the parameters of Gμ,σ with sufficient accuracy.

The complementary cumulative distribution function associated to curve Gμ,σ is the mathematical expression:

$$\frac{1}{2} ( 1 - erf ( \frac{X - μ}{σ \sqrt{2}} ) ) ,$$

where erf is the so-called Gaussian error function. More specifically, the parameters μ and σ may be deduced from the following system of two equations and two unknown values:

$$\frac{1}{4} ( 1 - erf ( \frac{{X}_{1} - μ}{σ \sqrt{2}} ) ) = Y 1 , \\ \frac{1}{4} ( 1 - erf ( \frac{{X}_{2} - μ}{σ \sqrt{2}} ) ) = Y 2 ;$$

where X1 and X2 are any two different classes higher than μ (7 and 8 in the example of FIG. 5), and Y1 and Y2, the normalized accumulated totals for classes X1 and X2.

Classes X1 and X2 may be consecutive. Generally, classes X1 and X2 are chosen at high enough values so that the effects of possible other density functions involved in the jitter characterization or produced by the measurement conditions are negligible. The observation interval is chosen so that values Y1 and Y2 are high enough to guarantee adequate accuracy. This observation interval may be chosen around one hundred milliseconds.

This system is also expressed by:

$$erf ( \frac{{X}_{1} - μ}{σ \sqrt{2}} ) = 1 - 4 Y 1 , \\ erf ( \frac{{X}_{2} - μ}{σ \sqrt{2}} ) = 1 - 4 Y 2 ,$$

which produces:

$$μ = \frac{{X}_{1} {E}_{2} - {X}_{2} {E}_{1}}{{E}_{2} - {E}_{1}} , \\ σ = \frac{{X}_{2} - {X}_{1}}{( {E}_{2} - {E}_{1} ) \sqrt{2}} ,$$

where E1=erf−1(1−4Y1) and E2=erf−1(1−4Y2), where erf-1 is the inverse Gaussian error function. Once these parameters are calculated, the error rate BER may be determined according to typical methods, as a function of the period of clock signal CKint.

As previously mentioned, it is desired to take jitter measurements in a production environment, during the test after manufacture. To that end, a BIST device is provided, in the circuits to be tested, in which the maximum possible functionality is integrated, while aiming to limit the occupied surface. To satisfy this constraint, the analysis tasks are distributed among the test equipment and the self-test device. The self-test device may be provided to collect values Y1 and Y2, and supply them to the test equipment which calculates the parameters μ and σ using these values and values X1 and X2 known by the equipment.

FIG. 6 schematically shows an embodiment of a self-test device satisfying these constraints, operating according to the exemplary digital timing diagram of FIG. 3. This device is associated to a test interface TEST-IF, for example, according to the JTAG standard, allowing data and signals to be exchanged in a standardized way with external test equipment, not shown.

The internal clock signal CKint to be observed is generally supplied by a phase-locked loop PLL1, which multiplies the frequency of an external clock signal CKext. This external clock signal is supplied, for example, by a crystal oscillator or, here, by the test equipment. The PLL is most often the origin of a major part of the jitter. Deterministic jitter may even be characteristic of the PLL structure. When there is no PLL, or in other test configurations, signal CKint may be observed far from its feed point into the circuit, for example, in the most remote leave of a clock tree.

Reference clock signal CKref, whose frequency is generally close to the frequency of signal CKint, may be generated from the same external clock signal CKext as signal CKint, by a second phase-locked loop PLL2. The multiplication rate of loop PLL2, different from the rate of loop PLL1 to create a beat frequency, may be fixed or programmable by the test equipment. Admittedly, loop PLL2 also introduces jitter, but this jitter, random by nature, is not susceptible of cancelling the jitter of loop PLL1. In fact, the system measures the contribution of both jitters.

Signal CKint is sampled by signal CKref using a latch 10. This latch produces beat signal Sbt, an example of which is shown in FIGS. 2 and 3. A second latch 12 is connected in a shift register with latch 10, i.e. latch 12 receives the output of latch 10 and is clocked by the same clock CKref. The outputs of latches 10 and 12 are provided to a XOR gate 14. The output of this gate corresponds to signal TR of FIG. 3, identifying by a “1,” each rising or falling transition of signal Sbt. In fact, XOR gate 14 detects each occurrence of the pattern 01 or 10 in the series of samples carried by signal Sbt.

The “detection” signal TR is applied to the enable input EN of a counter CNT-P clocked by signal CKref. Thus, counter CNT-P counts the number of cycles at 1 of signal TR, therefore the number of edges of signal Sbt, or the number of occurrences of the pattern 01 or 10 in the series of samples carried by signal Sbt.

The content of counter CNT-P is supplied to two digital comparators 16 and 17 whose thresholds correspond to classes X1 and X2 mentioned in relation with FIG. 5. These classes may be programmed by the test equipment. When the threshold of a comparator is reached by counter CNT-P, the comparator asserts an output applied to an enable input EN of a respective counter CNT-X1, CNT-X2. These counters are clocked at a lower frequency than that of signals CKint and CKref. They are preferably clocked by a signal 2Fbt having pulses at twice the theoretical beat frequency, and out of phase by a quarter of period. The edges of such a signal 2Fbt are shown by vertical lines in the digital timing diagram of FIG. 3. Signal 2Fbt is also used to reset counter CNT-P at each increment of counters CNT-X1 and CNT-X2.

Signal 2Fbt is, for example, generated from signal CKref by a programmable divider DIV. This divider comprises, for example, a counter reset each time it reaches the number of cycles (of signal CKref) corresponding to a theoretical half-period of signal Sbt. Counters CNT-X1 and CNT-X2 are reset by the test equipment at the beginning of an observation interval. At the end of the observation interval, they will contain values Y1 and Y2, before normalization.

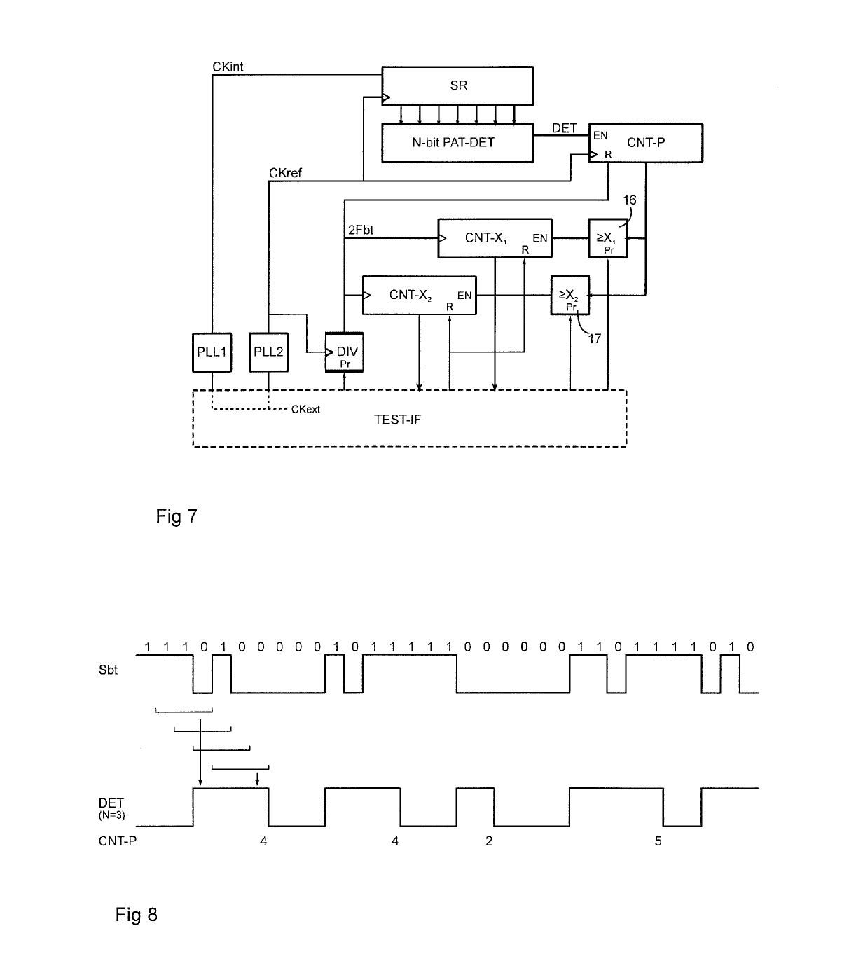

FIG. 7 shows another embodiment of a BIST device. Its structure is very similar to that of FIG. 6, and same elements, referred to by same references, will not be described again. In the device of FIG. 6, it is desired to count the occurrences of the patterns 01 and 10 in the series of samples carried by signal Sbt. To that end, a 2-bit shift register is used, whose outputs are analyzed by a XOR gate, used as pattern detector.

In FIG. 7, it is desired to count the occurrences of an N-bit pattern, where N is an integer greater than 2. To that end, a shift register SR is used, receiving signal CKint and clocked by signal CKref. N bits of shift register SR are supplied to a pattern detector PAT-DET, which enables counter CNT-P by a signal DET each time an occurrence of the pattern is detected.

It is in particular desired to detect the number of cycles between a first transition and a last transition of same direction inside a half-period of the beat signal. This allows finer jitter information to be obtained than by simply counting the transitions, which does not take into account the distance between transitions. An N-bit pattern complying with that is in fact any N-bit combination different from 1111 . . . 111 and 000 . . . 000. In other words, the compliance of the shift register content with the pattern is acquired when any two bits of the register differ. With such a pattern, as long as two successive edges are contained in an N-cycle window, counter CNT-P produces a value indicating the offset between the first and last measured edges of same direction.

FIG. 8 is a digital timing diagram illustrating this for an example of the beat signal Sbt and N=3. The contents of shift register SR for three consecutive cycles are shown by ranges depicted under the first transitions of signal Sbt. For an offset of 2 between the first and last transitions of same direction, 4 cycles are counted. For an offset of 3 (at the end of the digital timing diagram), there are 5. For an offset of 0 (ideal conditions), there are 2. Generally, the minimum count is N−1, and if C is the count reached in the counter, the offset is expressed by C−N+1.

To obtain the best results, number N is preferably chosen so that the biggest probable offset between the first and last measured edges is lower than N cycles. Nevertheless, lower values of N will produce good results, which are all the better as N is big. The calculations of jitter parameters explained for N=2 in relation with FIGS. 4 and 5 remain valid. The shape of the probability density function (FIG. 4) may vary in its central part, but it will always have a tail very rapidly tending toward a Gaussian function.

Many variations and modifications of the embodiments described here will clearly appear to those skilled in the art. Although a certain type of N-bit pattern has been described, which provides good results, it is not excluded, given the number of probabilities of different patterns offered by N bits, that those skilled in the art may find, by running trials, other patterns offering good results, and use with these patterns the principles described in the present application.

1-8. (canceled)

9. A method for characterizing jitter of an internal clock signal of a circuit, the method comprising:
generating a series of samples by sampling the internal clock signal based upon a reference clock signal;
comparing a word formed by N most recent samples of the series of samples to an N-bit pattern, N being an integer greater than or equal to 2; and
incrementing a first counter if the word complies with the N-bit pattern;
incrementing a second counter when the first counter reaches a first threshold;
incrementing a third counter when the first counter reaches a second threshold different from the first threshold;
periodically resetting the first counter; and
at the end of an observation interval, calculating an average and a standard deviation of a Gaussian density curve as a function of the second and third counters, the second and third counters being accumulated totals for first and second classes of a histogram of a complementary cumulative distribution function associated to the Gaussian density curve.

10. The method of claim 9 wherein the word complies with the N-bit pattern when any two bits of the word are different.

11. The method of claim 9 wherein the first and second thresholds comprise values for reducing effects of other density functions involved in the jitter characterization and produced by measurement conditions.

12. The method of claim 9 wherein the first counter is reset at a frequency which is twice a beat frequency between the internal clock signal and the reference clock signal.

13. The method of claim 9 wherein N equals 2; and wherein the N-bit pattern comprises at least one of 01 and 10.

14. The method of claim 9 wherein the average of the Gaussian density curve is expressed by:
$$μ = \frac{{X}_{1} {E}_{2} - {X}_{2} {E}_{1}}{{E}_{2} - {E}_{1}} ;$$
and
wherein the standard deviation of the Gaussian density curve is expressed by:
$$σ = \frac{{X}_{2} - {X}_{1}}{( {E}_{2} - {E}_{1} ) \sqrt{2}} ;$$
wherein E₁=erf⁻¹(1−4Y₁); wherein E₂=erf⁻¹(1−4Y₂); wherein Y₁ and Y₂ are normalized values of the first and second counters;
wherein erf⁻¹ is an inverse Gaussian error function; and wherein X₁ and X₂ are the first and second classes.

15. A method for characterizing jitter of an internal clock signal of a circuit, the method comprising:
generating a series of samples by sampling the internal clock signal based upon a reference clock signal;
incrementing a first counter when any two bits of a word formed by two most recent samples of the series of samples are different;
incrementing a second counter when the first counter reaches a first threshold;
incrementing a third counter when the first counter reaches a second threshold different from the first threshold;
periodically resetting the first counter; and
at the end of an observation interval, calculating an average and a standard deviation of a Gaussian density curve as a function of the second and third counters, the second and third counters being accumulated totals for first and second classes of a histogram of a complementary cumulative distribution function associated to the Gaussian density curve.

16. The method of claim 15 wherein the first and second thresholds comprise values for reducing effects of other density functions involved in the jitter characterization and produced by measurement conditions.

17. The method of claim 15 wherein the first counter is reset at a frequency which is twice a beat frequency between the internal clock signal and the reference clock signal.

18. The method of claim 15 wherein the average of the Gaussian density curve is expressed by:
$$μ = \frac{{X}_{1} {E}_{2} - {X}_{2} {E}_{1}}{{E}_{2} - {E}_{1}} ;$$
and
wherein the standard deviation of the Gaussian density curve is expressed by:
$$σ = \frac{{X}_{2} - {X}_{1}}{( {E}_{2} - {E}_{1} ) \sqrt{2}} ;$$
wherein E₁=erf⁻¹(1−4Y₁); wherein E₂=erf⁻¹(1−4Y₂); wherein Y₁ and Y₂ are normalized values of the first and second counters;
wherein erf⁻¹ is an inverse Gaussian error function; and wherein X₁ and X₂ are the first and second classes.

19. A built-in self-test (BIST) circuit for characterizing jitter of an internal clock signal, the BIST circuit comprising:
a shift register configured to receive the internal clock signal and to be clocked by a reference clock signal;
a detector configured to evaluate compliance of content of said shift register with an N-bit pattern, N being an integer greater than or equal to 2;
a first counter configured to be incremented by said detector based upon a compliance detection;
a second counter configured to be incremented when said first counter reaches a first threshold;
a third counter configured to be incremented when said first counter reaches a second threshold different from the first threshold; and
a management circuit configured to clock said second and third counters at an operating frequency based upon a beat frequency between the internal clock signal and the reference clock signal, and to reset said first counter based upon the operating frequency.

20. The BIST circuit of claim 19 wherein the operating frequency is twice the beat frequency between the internal clock signal and the reference clock signal.

21. The BIST circuit of claim 19 wherein said detector is configured to supply an active signal when any two bits of said shift register differ.

22. The BIST circuit of claim 19 wherein the word complies with the N-bit pattern when any two bits of the word are different.

23. The BIST circuit of claim 19 wherein the first and second thresholds comprise values for reducing effects of other density functions involved in the jitter characterization and produced by measurement conditions.

24. The BIST circuit of claim 19 wherein N equals 2; and wherein the N-bit pattern comprises at least one of 01 and 10.

25. A built-in self-test (BIST) circuit for characterizing jitter of an internal clock signal, the BIST circuit comprising:
a shift register configured to receive the internal clock signal and to be clocked by a reference clock signal;
a detector configured to evaluate compliance of content of said shift register with an 2-bit pattern, and to supply an active signal when any two bits of said shift register differ;
a first counter configured to be incremented by said detector based upon the active signal;
a second counter configured to be incremented when said first counter reaches a first threshold;
a third counter configured to be incremented when said first counter reaches a second threshold different from the first threshold; and
a management circuit configured to clock said second and third counters at an operating frequency which is twice a beat frequency between the internal clock signal and the reference clock signal, and to reset said first counter based upon the operating frequency.

26. The BIST circuit of claim 25 wherein the word complies with the 2-bit pattern when any two bits of the word are different.

27. The BIST circuit of claim 25 wherein the first and second thresholds comprise values for reducing effects of other density functions involved in the jitter characterization and produced by measurement conditions.

28. The BIST circuit of claim 25 wherein the N-bit pattern comprises at least one of 01 and 10.
